(19) United States
(12) Patent Application Publication
(10) Pub. No.: US 2012/0327473 A1
(43) Pub. Date: Dec. 27, 2012

(54) IMAGE FORMING APPARATUS, METHOD FOR CONTROLLING STARTUP OF IMAGE FORMING APPARATUS, AND STORAGE MEDIUM

(75) Inventor: Yoshiharu Ito, Kawasaki-shi (JP)

(73) Assignee: CANON KABUSHIKI KAISHA, Tokyo (JP)

(21) Appl. No.: 13/494,670

(22) Filed: Jun. 12, 2012

(30) Foreign Application Priority Data
Jun. 22, 2011 (JP) 2011-137930

(51) Int. Cl. G06K 15/00

(52) U.S. Cl. 358/1.16

(57) ABSTRACT

An image forming apparatus includes a storage unit configured to store a startup file for determining an initialized state of a plurality of devices, and a storage unit configured to store a state of each device after initialization as a startup image. When a shutdown request is issued, the image forming apparatus compares the startup file of any device specified by the startup image with the stored corresponding startup file to determine whether the state is changed. In a case where it is determined that the state of the startup file is changed, the image forming apparatus deletes the startup image stored in the storage unit for the state.

### BACKGROUND OF THE INVENTION

1. Field of the Invention

The present invention relates to an image forming apparatus, a method for controlling startup of an image forming apparatus, and a storage medium.

2. Description of the Related Art

Existing image forming apparatuses have tendency of an increase in the time from user's turning on a power source switch thereof until the operation becomes ready with high performance. To solve this problem, there is a speed-up technique using the Advanced Configuration and Power Interface (ACPI)-S3 method, according to which a main storage memory is maintained in a power-on state when the user turns off a power source switch. Further, Japanese Patent Application Laid-Open No. 2002-123401 discusses a technique for enabling high speed startup in which startup processing is performed by appropriately changing the processing content at the next startup based on information at the time of the previous startup. In the image forming apparatus, use of the ACPI method allows an operating system (OS) to play a central role to precisely set and manage power control functions of the respective devices.

However, for example, according to the ACPI-S3 method, the information processing apparatus records the state at the time of the previous shutdown, and operates to recover this state. In this case, the control program cannot be reset, thereby leading to a possibility of, for example, further advancement of memory fragmentation.

As a different technique to solve this problem, there is also a technique (referred to as snapshot startup), which stores a memory image at the time of an operation start in a secondary storage apparatus as a snapshot, and performs only transmission of the memory image at the next startup, thereby speeding up the startup processing.

However, according to this snapshot startup, the image forming apparatus cannot start to operate in a state other than the state when the memory image is generated, whereby the snapshot startup cannot flexibly attend to a request of changing the initial state at the time of startup, for example, the content of a screen display at the time of startup.

### SUMMARY OF THE INVENTION

The present invention is directed to providing an image forming apparatus, even under an high speed startup environment, for switching initialization processing with use of a startup image to initialization processing based on an updated startup file in response to an operation for changing the startup file from a user after initialization processing, thereby flexibly attending to a user's request.

According to an aspect of the present invention, an image forming apparatus includes a first storage unit configured to store a startup file for determining an initialized state of a plurality of devices, an initialization unit configured to initialize each device based on the startup file stored in the first storage unit, a second storage unit configured to store a state of each device after initialization by the initialization unit as a startup image, a reception unit configured to receive a setting change of the startup file related to the plurality of devices after the initialization by the initialization unit, a reflection unit configured to reflect the setting change received by the reception unit to the startup file stored in the first storage unit for the startup file, a determination unit configured, when a shutdown request is issued, to determine whether the state is changed by comparing the startup file of any device specified by the startup image with the corresponding startup file stored in the first storage unit for the start up file and a deletion unit configured, in a case where the determination unit determines that the state of any startup file is changed, to delete the startup image stored in the second storage unit for the state.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image forming system.

FIG. 2 is a block diagram illustrating a configuration of a controller illustrated in FIG. 1.

FIG. 3 is a block diagram illustrating a configuration of a power source of an image forming apparatus according to an exemplary embodiment.

FIG. 4 is a flowchart illustrating a method for controlling the image forming apparatus according to the exemplary embodiment.

FIG. 5 illustrates a state change list associated with a startup file.

FIG. 6 illustrates the state change list associated with the startup file.

FIG. 7 illustrates the state change list associated with the startup file.

### DESCRIPTION OF THE EMBODIMENTS

Various exemplary embodiments, features, and aspects of the invention will be described in detail below with reference to the drawings.

Hereinafter, an embodiment of the present invention will be described in detail with reference to the drawings by way of example. However, the constituent elements, which will be described below in the description of the exemplary embodiment, are merely an example, and it should be noted that they are not intended to limit the scope of the present invention in any way.

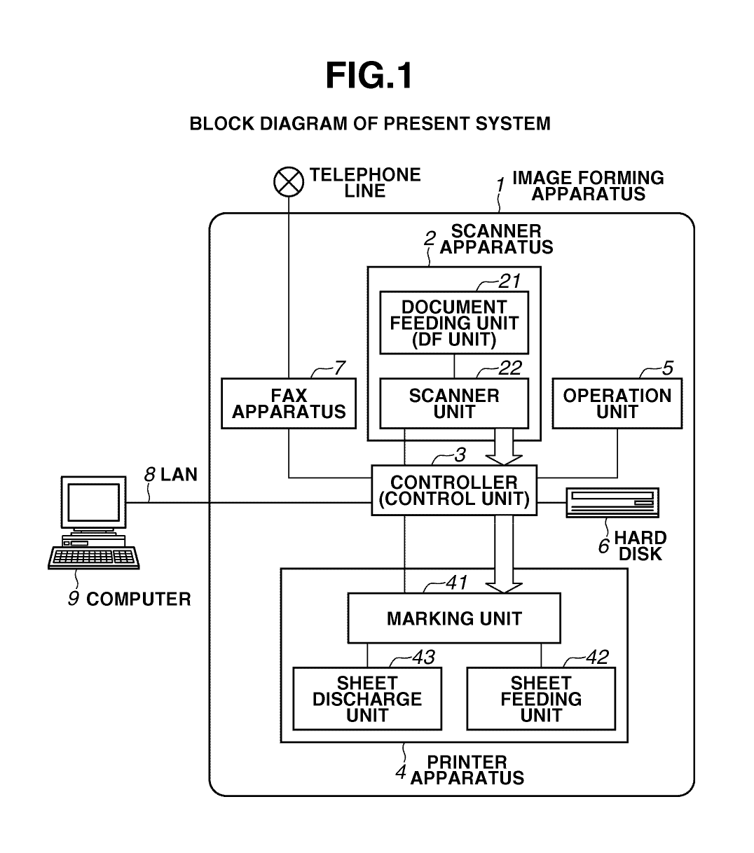

A first exemplary embodiment will be described. FIG. 1 is a block diagram illustrating the configuration of an image forming system including an image forming apparatus according to the present exemplary embodiment. This example corresponds to an image forming system in which a computer 9 and an image forming apparatus 1 are bidirectionally communicable via a local area network (LAN) 8. In the present exemplary embodiment, apparatuses indicated by the term “device” include, for example, a display apparatus used for an operation unit 5, a printer apparatus, a scanner apparatus, and a facsimile (FAX) apparatus.

Referring to FIG. 1, a scanner apparatus 2 optically reads an image from a document to convert it into a digital image. A printer apparatus 4 outputs the digital image onto a paper medium. The printer apparatus 4 is used in a print job received from the computer 9 or a copy job for printing an image read by the scanner apparatus 2.

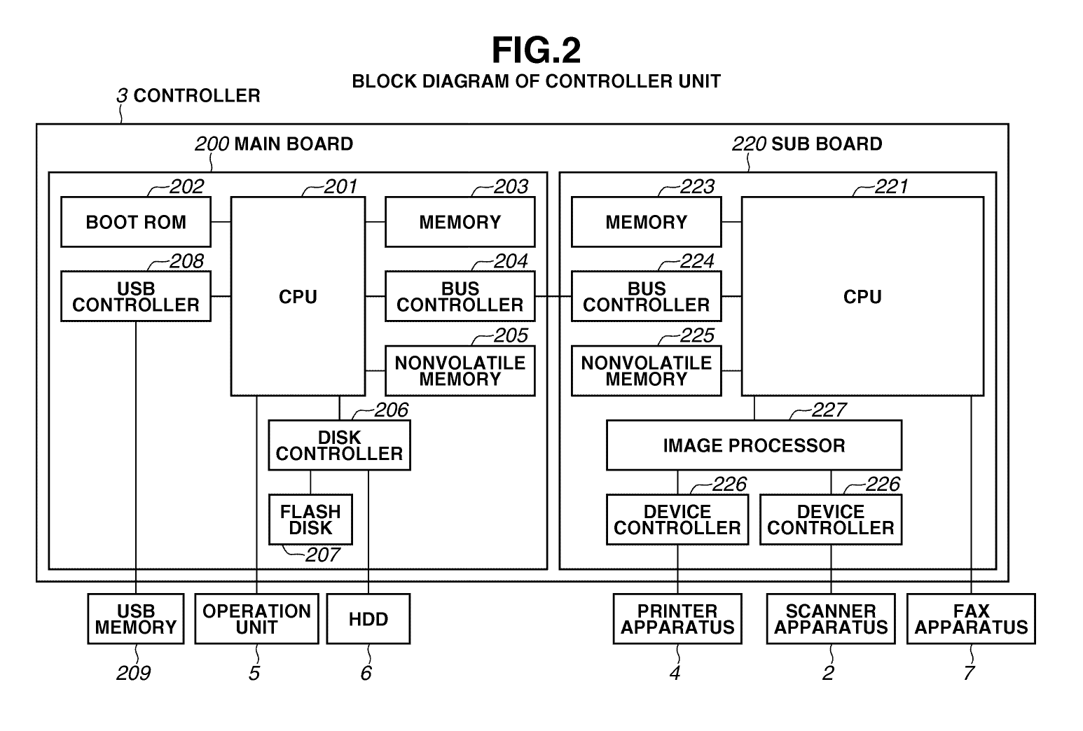

An operation unit 5 receives a request from a user via a touch panel form, and displays a user interface according to the function processing. A hard disk 6 stores, for example, image data read by the scanner apparatus 2, a control program, and a startup file for determining the initialized state of a plurality of devices. The facsimile apparatus (FAX apparatus) 7 transmits and receives image data to and from, for example, a telephone line. A controller 3 includes hardware resources illustrated in FIG. 2, and controls the entire image forming apparatus 1. Further, the image forming apparatus 1 can, for example, input/output a digital image to/from the computer 9 via the LAN 8 and issue a job and an instruction to a device from the computer 9 via the LAN 8.

The scanner apparatus 2 includes a document feeding unit 21, which can automatically sequentially replace a document stack, and a scanner unit 22, which can optically scan a document to convert the content of the document into a digital image. The converted image data is transmitted to the controller 3. Further, the printer apparatus 4 includes a sheet feeding unit 42, which can sequentially feed a sheet from a sheet stack one by one, a marking unit 41 for printing image data onto the fed sheet, and a sheet discharge unit 43 for discharging the printed sheet. Now, jobs that the image forming apparatus 1 illustrated in FIG. 1 can carry out will be described. The image forming apparatus 1 can carry out various kinds of jobs. Examples of such jobs are as follows. First function processing is a copy function, according to which the image forming apparatus 1 records an image read by the scanner apparatus 2 on the hard disk apparatus (hard disk drive (HDD)) 6 and prints the image by using the print apparatus 4 simultaneously. Second function processing is an image transmission function, according to which the image forming apparatus 1 transmits an image read by the scanner apparatus 2 to the computer 9 via the LAN 8.

Third function processing is an image saving function, according to which the image forming apparatus 1 records an image read by the scanner apparatus 2 on the HDD 6, and transmits or prints the image as necessary. Fourth function processing is an image print function, according to which the image forming apparatus 1 interprets, for example, a page description language transmitted from the computer 9, and prints by using the printer apparatus 4. FIG. 2 is a block diagram illustrating the configuration of the controller 3 illustrated in FIG. 1. Referring to FIG. 2, the controller 3 includes a main board 200 and a sub board 220.

Referring to FIG. 2, the main board 200 is constituted by a commonly-used central processing unit (CPU) system, and includes a CPU 201 in charge of control of the entire board. A boot read only memory (boot ROM) 202 stores a boot program. A memory 203 is used by the CPU 201 as a work memory. A bus controller 204 has a bridge function for communication with an external bus. A non-volatile memory 205 can retain information even when the image forming apparatus 1 is powered off.

Further, the main board 200 includes a disk controller 206, which controls the HDD 6 as a storage apparatus. The disk controller 206 also controls access to a flash disk (for example, a solid-state drive (SSD)) 207, which is a relatively low-capacity storage apparatus constituted by a semiconductor device. A universal serial bus (USB) controller 208 controls access to a USB memory 209. The USB memory 209, the operation unit 5, the HDD 6, and the like are externally connected to the main board 200.

A sub board 220 is constituted by a relatively small commonly-used CPU system and an image processing hardware. The sub board 220 includes a CPU 221 for controlling the entire board. A memory 223 is used by the CPU 221 as a work memory. A bus controller 224 has a bridge function for communication with an external bus. A non-volatile memory 225 can retain information even when the image forming apparatus 1 is powered off. Further, the sub board 220 includes an image processer 227, which performs real-time digital image processing, and device controllers 226. The device controllers 226 transmit and receive digital image data to and from the scanner apparatus 2 and the printer apparatus 4. The FAX apparatus 7 is directly controlled by the CPU 221.

FIG. 2 is a block diagram merely schematically illustrating the CPU configuration. For example, actually, the CPU 201, the CPU 221, and the like include a number of CPU peripheral hardware such as a chip set, a bus bridge, and a clock generator, but they are not especially illustrated in FIG. 2 since their illustration is not necessary in consideration of the granularity of the present description. As such, this block configuration does not limit the present invention. Hereinafter, an operation of the controller 3 will be described based on an example of image copying processing.

When a user instructs the image forming apparatus 1 to copy an image from the operation unit 5, the CPU 201 transmits an image reading command to the scanner apparatus 2 via the CPU 221 of the sub board 220. The scanner apparatus 2 optically scans a sheet document, and inputs the read image data to the image processing processor 227 via the device controller 226. The image processing processor 227 performs direct memory access (DMA) transfer to the memory 223 via the CPU 221 to temporarily store the image data.

After the CPU 201 confirms that a certain amount or all of the image data is stored in the memory 223, the CPU 201 issues an image output instruction to the printer apparatus 4 via the CPU 221. The CPU 221 notifies the image processing processor 227 of the location of the image data in the memory 223. The image data in the memory 223 is transmitted to the printer apparatus 4 via the image processing processor 227 and the device controller 226 according to a synchronization signal from the printer apparatus 4. The printer apparatus 4 prints the image data read from the document on a sheet material as a copied image.

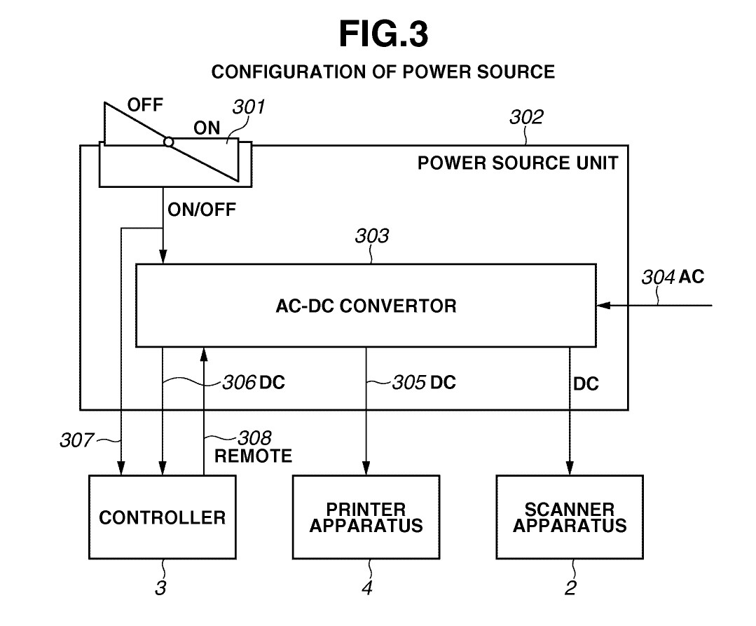

If the printer apparatus 4 prints a plurality of copies of the image data at this time, the CPU 201 saves the image data in the memory 223 on the HDD 6, and for the second copy and the subsequent copies, the CPU 201 can transmit the saved image data to the printer apparatus 4 in synchronization with the printer apparatus 4 without receiving the image from the scanner apparatus 2. FIG. 3 is a block diagram illustrating a power source configuration of the image forming apparatus 1 according to the present exemplary embodiment.

Referring to FIG. 3, the power source configuration includes a toggle-type switch 301, a power source unit 302, an alternating current-direct current (AC-DC) convertor 303, and an AC power source input unit 304. A power source cable 305 supplies DC power to the printer apparatus 4. A power source cable 306 supplies power to the controller 3. A control line 307 notifies the controller 3 of the state of the toggle-type switch 301. A power source remote signal line 308 controls an output of the AC-DC convertor 303.

An operator can turn on and off the present image forming apparatus 1 by operating the toggle-type switch (switch) 301. When the toggle-type switch 301 is turned on, the toggle-type switch 301 is connected to the AC-DC convertor 303, and therefore can control the power supplying state of the power source.

Further, when the toggle-type switch 301 is turned off, the power supply of the power source line 306 is controlled not to be stopped until the controller 3 completes shutdown of the system. More specifically, the state of the power source switch 301 is reported to the controller 3 via the control line 307, and the DC power supply via the power source line 306 is controlled to be stopped after completion of shutdown with use of a power source remote signal of the control line 307. The above description corresponds to the power source configuration of a common apparatus that requires shut down. The above-described toggle-type switch 301 is configured as a switch mechanically retaining any one of an ON state and an OFF state. The operator instructs state of turning on or turning off of a power supply by turning the toggle-type switch 301 to ON side or OFF side.

The present exemplary embodiment employs the toggle-type switch in which the OFF state and the ON state are explicit. However, for example, many personal computers employ a power source switch that does not have any specific state (including the case where, for example, a power source switch itself functions as a switch for shifting to a power saving mode). The switch that does not have a specific state functions under a first control pattern, as “ON/shift to a power saving mode” when the apparatus is already powered on, functions under a second control pattern, as “ON” when the apparatus is powered off, and functions under a third control pattern, as “forcibly OFF” by being pushed down for a predetermined time or longer. Therefore, the present exemplary embodiment is not limited to the toggle-type switch. The present exemplary embodiment can be applied to the switch that does not have a status by applying the ON/OFF of the toggle-type switch to the first and the second ON/OFF control pattern.

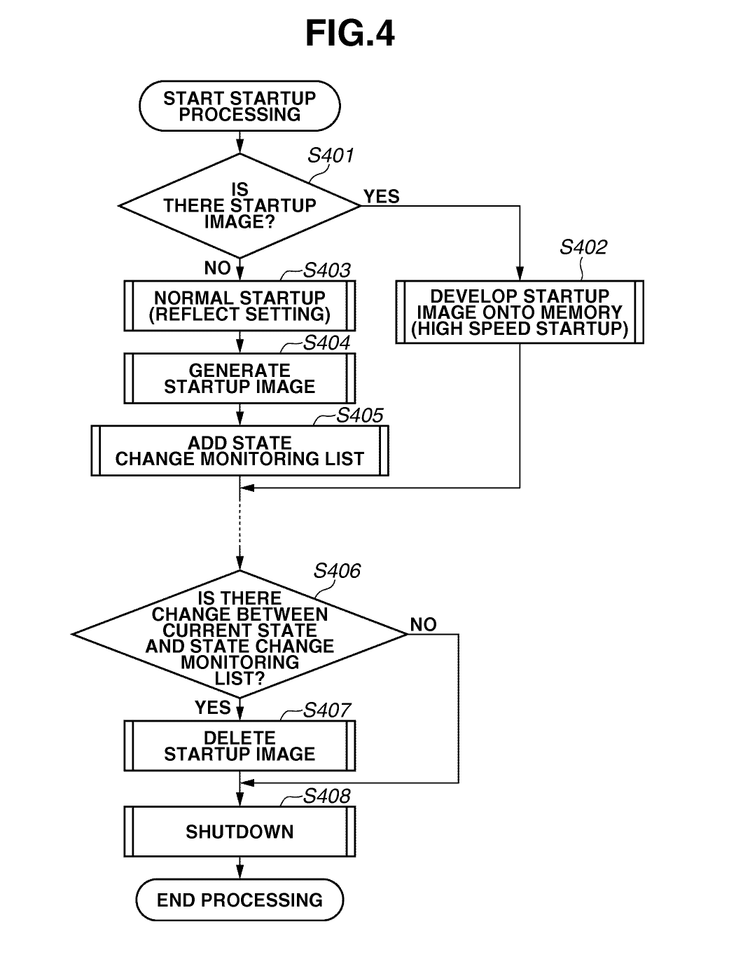

FIG. 4 is a flowchart illustrating a method for controlling the image forming apparatus 1 according to the present exemplary embodiment. The present example is a processing example based on a basic operation of high speed startup using a memory image. The CPU 201 loads, for example, a control program, a startup file, and a startup image to the memory 203 to execute them, by which the respective steps are realized. Hereinafter, a description will be given of startup control for detecting a change status of a startup file after initialization and switching initialization processing using a startup image to initialization processing based on an updated startup file. Further, the present exemplary embodiment is configured in such a manner that the CPU 201 can perform shutdown processing according to the mode specified by ACPI-S3. First, in step S401, the CPU 201 discriminates whether there is a startup image. The startup image is stored in the HDD 6, and is an image in which the CPU 201 stores the content of the memory 203 when the apparatus is operating. In step S401, if the CPU 201 discriminates that the startup image is stored, and that the startup image exists in the HDD 6 (YES in step S401), the processing proceeds to step S402, in which the CPU 201 performs high speed startup processing using the startup image.

The concept of the startup using a startup image is similar to startup from a hibernation state, which is the technique about instant startup of an operating system working on a personal computer, and therefore a detailed description thereof will be omitted herein.

On the other hand, if the CPU 201 determines in step S401 that a startup image does not exist in the HDD 6 (NO in step S401), the processing proceeds to step S403, in which the CPU 201 performs normal startup processing. Generally, as the normal startup processing, for example, the CPU 201 loads, activates, and initializes an operating system, and loads, activates, and initializes an application.

When the CPU 201 initializes an application, the CPU 201 refers to a file or the like storing the settings of the application, and starts the operation after appropriately changing the initial state. The file or the like storing the settings will be described later.

After the startup processing and the initialization processing are completed in step S403, in step S404, the CPU 201 generates a startup image. This is the startup image to be used in the determination in step S401. The startup image is generated at this stage to store a relatively clean state immediately after startup. Therefore, since some inconvenience may be caused by allowing, for example, a copy operation and a page description language (PDL) print operation, which are primary operations of the image forming apparatus 1, during the generation of the startup image, it is required to prohibit an input of a job.

Subsequently, in step S405, the CPU 201 generates a list of a file that is used to generate the above-described startup image and stores the settings indicating the state of the apparatus. The startup image includes the state of the apparatus, and therefore this file list is in one-to-one correspondence with the generated startup image. After completion of this processing, the image forming apparatus 1 performs its primary target processing such as a copy operation or a PDL print operation. Step S406 and the steps thereafter are performed when the image processing apparatus 1 completes operations. In step S406, the CPU 201 compares the previously generated state change list and the current state of the image forming apparatus 1. As a result of the comparison, if the CPU 201 determines that there is no difference in particular therebetween (NO in step S406), the processing proceeds to step S408, in which the CPU 201 performs shutdown processing (shutdown processing according to the mode specified by ACPI-S3) according to a shutdown request. Then, the present processing is ended.

On the other hand, as a result of the comparison, if the CPU 201 determines that there is a difference between the previously generated state change list and the current state of the image forming apparatus 1 (YES in step S406), the processing proceeds to step S407. In step S407, the CPU 201 deletes the startup image stored in the HDD 6. As a result of execution of this deletion processing, the CPU 201 determines that there is “NONE” of a startup image in the determination of existence or absence of a startup image in step S401 at the time of the next startup, so that the CPU 201 regenerates a startup image without fail.

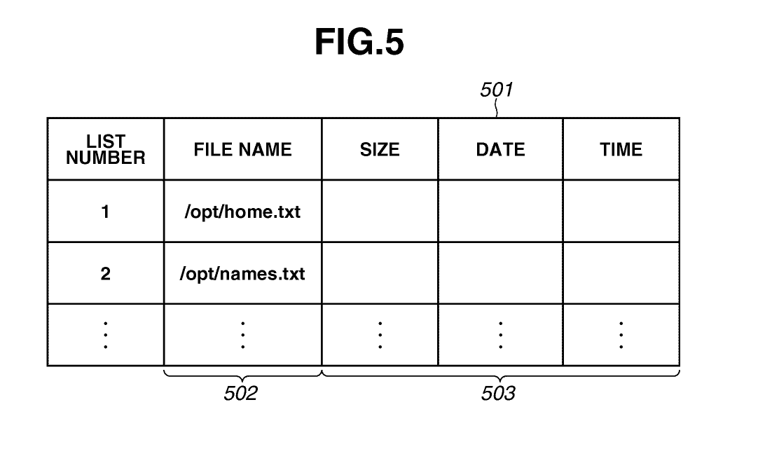

FIGS. 5 to 7 each illustrate an example of the status change list associated with the startup file managed by the image forming apparatus 1 according to the present exemplary embodiment. Referring to FIG. 5, a status change list 501 is an example of the status change list generated upon reception of an instruction for changing a startup file, which is issued from a user, in step S405 and the steps thereafter illustrated in FIG. 4 as described above, for example, after the initialization processing. The contents of the status change list 501 is mainly classified into an item name 502 and detailed information 503.

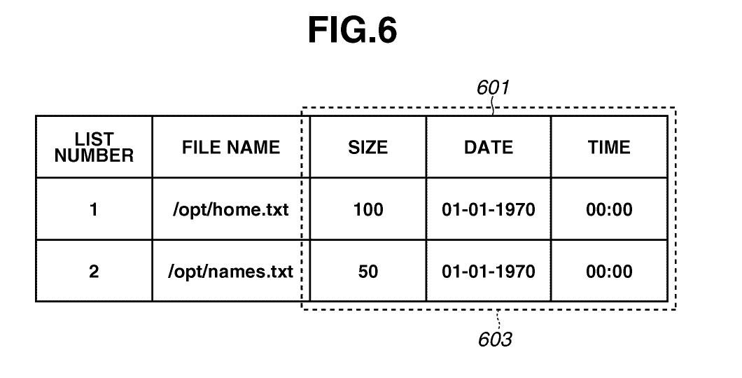

The detailed information 503 is constituted by information for guaranteeing the uniqueness of information which is included in the item name 502. In the present example, assuming that the item is stored as a file, the item name 502 includes a filename, and the detailed information 503 includes information about the size of the file and the modified date/time of the file. The detailed information 503 may be any information capable of guaranteeing the uniqueness of target information, and may be substituted by, for example, a hash value calculated according to the widely used Message Digest 5 (MD5) hash algorithm. FIG. 6 illustrates a specific example of the state change list generated in step S405 illustrated in FIG. 4. In this example, there are two files (“/opt/home.txt” and “/opt/names.txt”) as the items, and the detailed information 503 (the size, the date, and the time) corresponding to them is registered in the status change list.

The image forming apparatus 1 is configured in such a manner that, if the image forming apparatus 1 determines that the image forming apparatus 1 receives a user's operation for changing the initial screen displayed when the image forming apparatus 1 is powered on while the image forming apparatus 1 is operating according to the startup image, the image forming apparatus 1 rewrites that information in the file “/opt/home.txt” according to the change of the initial screen as a normal operation independently of the present invention. The rewritten file is referred to as a startup file, and the startup file is updated and stored in the HDD 6. Then, the initialization processing is performed with use of the updated and newly stored startup file, instead of the startup image, during the next startup processing. Then, the startup image generated during the execution of the initialization processing is referred to at the time of the next initialization processing, whereby the image forming apparatus 1 is started up showing the initial screen reflecting the setting changed by the user in the startup processing thereafter. The startup file is used as a file for specifying the initial setting screen displayed on the display apparatus.

The CPU 201 refers to the state change list 601 to compare with the existing state of the apparatus in step S406 illustrated in FIG. 4. For example, assuming that the file size in the detailed information 603 is changed from “100” to “120” by rewriting, in step S406, as a result of the comparison, the CPU 201 can detect from the update of the file size that the state is changed.

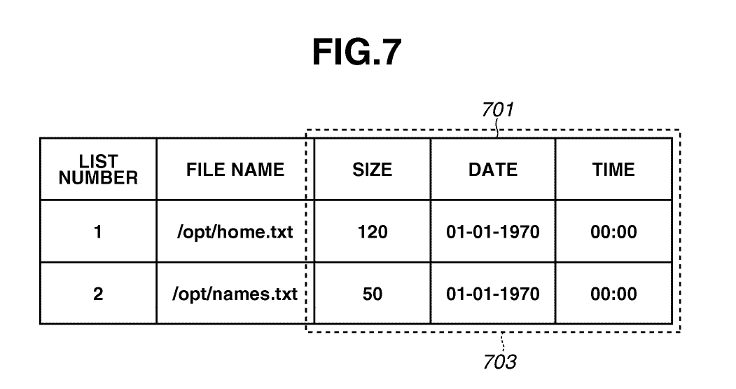

FIG. 7 illustrates the state of the apparatus at the time of step S406 illustrated in FIG. 4 in the form of the state change list 701 for facilitating better understanding of the present example. Since there is a difference in the file size of the list number 1 (the file size of the list number 1 is “100” in the detailed information 603 illustrated in FIG. 6, and this file size is changed to “120” in the detailed information 703 illustrated in FIG. 7), it is possible to detect the state change of the image forming apparatus 1. According to the present exemplary embodiment, it is possible to not only enable high speed startup of the image forming apparatus 1 but also prevent, for example, the advancement of fragmentation of the memory, which may be otherwise caused by the inability to reset the control program in a case where the startup processing is performed with use of the method of storing the state at the time of the previous shutdown and recovering that state according to, for example, the ACPI-S3 method. Further, according to the snapshot startup, the image forming apparatus 1 cannot start an operation in a status other than the status when the memory image is generated. However, according to the present exemplary embodiment, the startup image is regenerated every time a setting change is detected, whereby it is possible to even flexibly change the initial state according to, for example, a user's operation.

The respective steps in the present exemplary embodiment can be also realized by causing a processing unit (a CPU or a processor) of, for example, a personal computer (computer) to execute software (a program) acquired via a network or various kinds of storage media.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-137930 filed Jun. 22, 2011, which is hereby incorporated by reference herein in its entirety.

What is claimed is:

1. An image forming apparatus comprising:
a first storage unit configured to store a startup file for determining an initialized state of a plurality of devices;
an initialization unit configured to initialize each device based on the startup file stored in the first storage unit;
a second storage unit configured to store a state of each device after initialization by the initialization unit as a startup image;
a reception unit configured to receive a setting change of the startup file related to the plurality of devices after the initialization by the initialization unit;
a reflection unit configured to reflect the setting change received by the reception unit to the startup file stored in the first storage unit for the startup file;
a determination unit configured, when a shutdown request is issued, to determine whether the state is changed by comparing the startup file of any device specified by the startup image with the corresponding startup file stored in the first storage unit for the start up file; and
a deletion unit configured, in a case where the determination unit determines that the state of any startup file is changed, to delete the startup image stored in the second storage unit for the state.

2. The image forming apparatus according to claim 1, further comprising:
a discrimination unit configured, when the image forming apparatus is powered on, to discriminate whether the startup image is stored in the second storage unit for the state,
wherein the startup image is read out to a memory and the initialization processing is completed, in a case where the discrimination unit discriminates that the startup image is stored, and the initialization unit reads out the startup file stored in the first storage unit for the startup file and performs the initialization processing, in a case where the discrimination unit discriminates that the startup image is not stored.

3. The image forming apparatus according to claim 1, wherein the devices include a display apparatus, a printer apparatus, a scanner apparatus, and a facsimile apparatus.

4. The image forming apparatus according to claim 1, wherein the startup file is a file for specifying an initial setting screen to be displayed on a display apparatus.

5. The image forming apparatus according to claim 1, wherein the shutdown is performed according to a mode specified by ACPI-S3.

6. The image forming apparatus according to claim 1, wherein the second storage unit for the state comprises a non-volatile memory.

7. A method for controlling an image forming apparatus including a first storage unit configured to store a startup file for determining an initialized state of a plurality of devices, and a second storage unit configured to store a state of each device after initialization as a startup image, the method comprising:
reading out the startup file stored in the first storage unit for the startup file and initializing each device;
receiving a setting change of the startup file related to the plurality of devices after the initialization processing;
reflecting the received setting change to the startup file stored in the first storage unit for the startup file;
determining, when a shutdown request is issued, whether the state is changed by comparing the startup file of any device specified by the startup image with the corresponding startup file stored in the first storage unit for the start up file; and
deleting the startup image stored in the second storage unit for the state, in a case where it is determined in the determination that the state of any startup file is changed.

8. A non-transitory computer-readable storage medium storing a program for causing a computer to execute the method for controlling the image forming apparatus according to claim 7.

9. An image forming apparatus comprising:
a first storage unit configured to store a startup file for determining an initialized state of a plurality of devices;
an initialization unit configured to initialize each device based on the startup file stored in the first storage unit;
a second storage unit configured to store a state of each device after initialization by the initialization unit as a startup image;
a reception unit configured to receive a setting change of the startup file after the initialization by the initialization unit;
a reflection unit configured to reflect the setting change received by the reception unit to the startup file stored in the first storage unit for the startup file; and
a deletion unit configured, when the startup file stored in the first storage unit is reflected by the reflection unit at the time of issuance of a shutdown request, to delete the startup image stored in the second storage unit.
